(19) United States
(12) Patent Application Publication
(10) Pub. No.: US 2010/0262708 A1
(43) Pub. Date: Oct. 14, 2010

(54) METHOD AND APPARATUS FOR DELIVERY OF SCALABLE MEDIA DATA

(75) Inventors: Imed Bouazizi, Tampere (FI); Lukasz Kondrad, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/420,610

(22) Filed: Apr. 8, 2009

(51) Int. Cl. G06F 15/16; H04N 7/12

(52) U.S. Cl. 709/231; 375/240.26; 375/E07.02

(57) ABSTRACT

In accordance with an example embodiment of the present invention, a method and apparatus are described for assigning layers of a scalable media stream to one or more groups. A data type value is assigned to least one group, and the at least one group is mapped to a physical layer pipe. Data of the scalable media stream is transmitted in the physical layer pipe in a data frame, and a lowest data type value of groups of layers transmitted in the physical layer pipe in the data frame is signaled in the transmission of the data frame. Further, a corresponding method and apparatus are disclosed for receiving data from a scalable media stream.

### TECHNICAL FIELD

The present application relates generally to delivery of scalable media data.

### BACKGROUND

In a transmission of a media stream, the media stream may comprise one or more layers. For example, a media stream may comprise a video stream, an audio stream and/or other media data. A video stream may comprise layers of various video qualities. Scalable video coding (SVC) implements a layered coding scheme for encoding or decoding video sequences. Also, audio and other media data may be coded or decoded in a layered coding scheme. In an example embodiment, a scalable media stream is structured in a way that allows the extraction of one or more sub-streams. A sub-stream may be characterized by one or more properties of the media data transmitted in the layers.

A layer may have properties such as quality, temporal resolution, spatial resolution, and/or the like. A scalable video stream may comprise a base layer and one or more enhancement layers. Generally, the base layer carries a low quality video stream corresponding to a set of properties, for example for rendering a video content comprised in a media stream on an apparatus with a small video screen and/or a low processing power, such as a small handheld device like a mobile phone. One or more enhancement layers may carry information which may be used by an apparatus with a bigger display and/or more processing power. An enhancement layer improves one or more properties compared to the base layer. For example, an enhancement layer may provide an increased spatial resolution as compared to the base layer. Thus, a larger display of an apparatus may provide an enhanced video quality to the user by showing more details of a scene by supplying a higher spatial resolution. Another enhancement layer may provide an increased temporal resolution. Thus, more frames per second may be displayed allowing an apparatus to render motion more smoothly. Yet another enhancement layer may provide in increased quality by providing a higher color resolution and/or color depth. Thus, color contrast and rendition of color tones may be improved. A further enhancement layer may provide an increased visual quality by using a more robust coding scheme and/or different coding quality parameters. Thus, less coding artifacts are visible on the display of the apparatus, for example when the apparatus is used under conditions when the quality of the received signal that carries the transmission is low or varies significantly.

While a base layer that carries the low quality video stream requires a low bit or symbol rate, an enhancement layer may increase the bit or symbol rate and therefore increase the processing requirements of the receiving apparatus. An enhancement layer may be decoded independently, or it may be decoded in combination with the base layer and/or other enhancement layers.

The media stream may also comprise an audio stream comprising one or more layers. A base layer of an audio stream may comprise audio of a low quality, for example a low bandwidth, such as 4 kHz mono audio as used in some telephony systems, and a basic coding quality. Enhancement layers of the audio stream may comprise additional audio information providing a wider bandwidth, such as 16 kHz stereo audio or multichannel audio. Enhancement layers of the audio stream may also provide a more robust coding to provide an enhanced audio quality in situations when the quality of the received signal that carries the transmission is low or varies significantly.

### SUMMARY

Various aspects of examples of the invention are set out in the claims.

According to a first aspect of the present invention, a method is disclosed, comprising assigning layers of a scalable media stream to one or more groups and assigning a data type value to at least one group. At least one group is mapped to a physical layer pipe. Data of the scalable media stream is transmitted in the physical layer pipe in a data frame, and a lowest data type value of groups transmitted in the physical layer pipe in the data frame is signaled in the data frame.

According to a second aspect of the present invention, a method is described comprising determining at least one layer to receive from a scalable media stream. Signaling information related to a data frame is received, wherein the signaling information comprises a data type value corresponding to a lowest data type value of groups transmitted in a physical layer pipe in the data frame. The data type value is extracted from the signaling information, and it is asserted whether data in a physical layer pipe in the data frame comprises the determined at least one layer in a group based at least in part on the data type value.

According to a third aspect of the present invention, an apparatus is shown comprising a controller configured to assign layers of a scalable media stream to one or more groups, wherein the controller is further configured to assign a data type value to at least one group of layers, and wherein the controller is further configured to map the at least one group to a physical layer pipe. The apparatus further comprises a transmitter configured to transmit data of the scalable media stream in the physical layer pipe in a data frame. The transmitter is further configured to transmit in the data frame signaling information comprising a lowest data type value of groups transmitted in the physical layer pipe in the data frame.

According to a fourth aspect of the present invention, an apparatus is disclosed comprising a controller configured to determine at least one layer to receive from a scalable media stream. The apparatus further comprises a receiver configured to receive signaling information related to a data frame, wherein the signaling information comprises a data type value corresponding to a lowest data type value of groups transmitted in a physical layer pipe in the data frame. The controller is further configured to assert whether data in a physical layer pipe in the data frame comprises the determined at least one layer in a group based at least in part on the data type value.

According to a fifth aspect of the present invention, a computer program, a computer program product and a computer-readable medium bearing computer program code embodied therein for use with a computer are disclosed, the computer program comprising code for assigning layers of a scalable media stream to one or more groups, code for assigning a data type value to at least one group of layers, code for mapping the at least one group to a physical layer pipe, code for transmitting data of the scalable media stream in the physical layer pipe in a data frame; and code for signaling in the data frame a lowest data type value of groups transmitted in the physical layer pipe in the data frame.

According to a sixth aspect of the present invention, a computer program, a computer program product and a computer-readable medium bearing computer program code embodied therein for use with a computer are disclosed, the computer program comprising code for determining at least one layer to receive from a scalable media stream, code for receiving signaling information related to a data frame, wherein the signaling information comprises a data type value corresponding to a lowest data type value of groups transmitted in a physical layer pipe in the data frame, code for extracting the data type value from the signaling information; and code for asserting whether data in a physical layer pipe in the data frame comprises the determined at least one layer in a group based at least in part on the data type value.

### BRIEF DESCRIPTION OF THE DRAWINGS

For a more complete understanding of example embodiments of the present invention, reference is now made to the following descriptions taken in connection with the accompanying drawings in which:

FIG. 1 shows a transmission system according to an embodiment of the invention;

FIG. 2 shows an example embodiment of a data frame comprising signaling information;

FIG. 3 shows symbols of a data frame of a DVB transmission;

FIG. 4 shows an example embodiment of grouping layers of a scalable media stream;

FIG. 5 shows an example embodiment of a series of data frames or packets comprising a physical layer pipe (PLP) carrying multiple layers of a scalable media stream;

FIG. 6 shows an example embodiment of a transmission of a scalable media stream using signaling of groups of layers;

FIG. 7 shows a flowchart of an example embodiment method for transmitting a scalable media stream in one or more PLPs;

FIG. 8 shows a flowchart of an example embodiment method for receiving a scalable media stream in one or more PLPs;

FIG. 9 shows an example embodiment of an apparatus configured to transmit data of a scalable media stream; and

FIG. 10 shows an example embodiment of an apparatus configured to receive packets of a media stream.

### DETAILED DESCRIPTION OF THE DRAWINGS

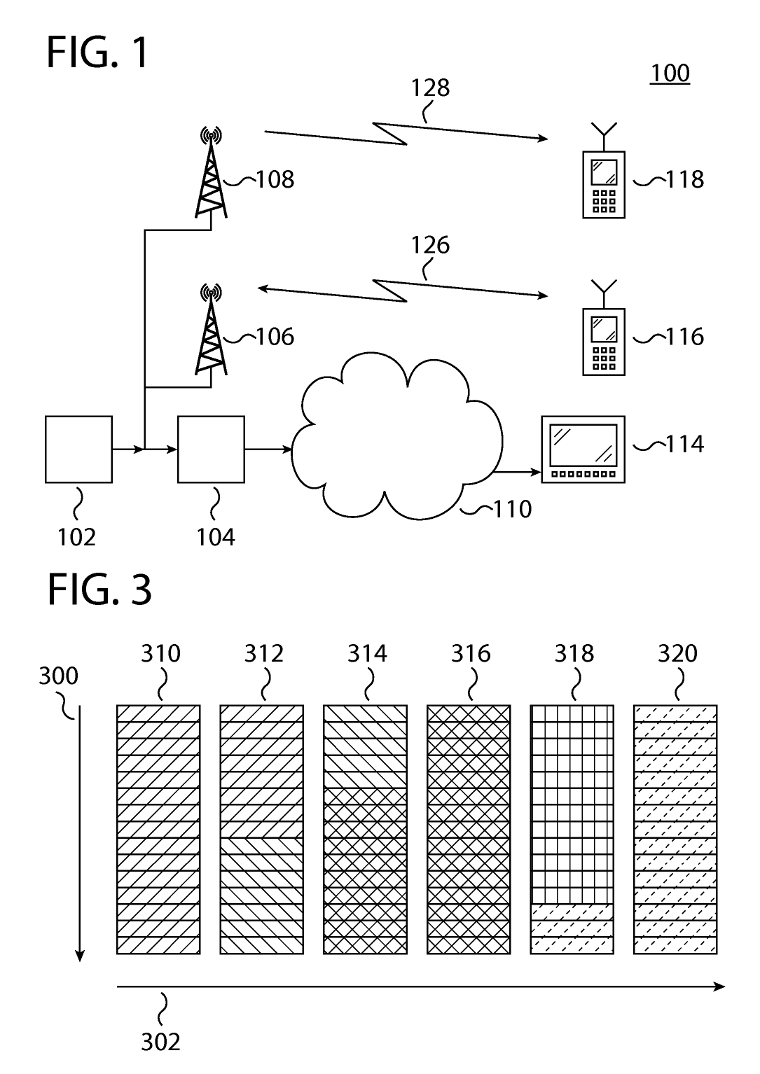

An example embodiment of the present invention and its potential advantages are understood by referring to FIGS. 1 through 10 of the drawings.

In a unicast, broadcast or multicast transmission, scalable video coding (SVC) may be used to address a variety of receivers with different capabilities efficiently. An apparatus comprising a receiver for scalable video coding may be configured to process one or more sub-streams by subscribing to a sub-set of layers of the media stream in accordance with a configuration at the apparatus, for example depending on the capabilities of the apparatus. The capabilities may be a display resolution, a color bit depth, a maximum bit rate capability of a video processor, a total data processing capability reserved for media streaming, audio and video codecs installed, and the like. Handling one or more sub-streams of the media stream by receiving a sub-set of layers may also be considered based at least in part on a user requirement within the limits of the processing and rendering capabilities of the apparatus. For example, a user may indicate a low, medium or high video quality and a low, medium or high audio quality. Especially in battery powered apparatuses there may be a trade-off between streaming quality and battery drain or battery life. Therefore, a user may configure the apparatus to use a low video quality and a medium audio quality. In this way, an operation point is selected that allows battery usage of the apparatus for a longer time as compared to a high video and audio quality. Thus, the apparatus may receive a subset of the layers of the transmission required to provide the media stream to the user at the selected operation point. The apparatus may not receive other layers that are not required.

In a transmission, SVC may be used to address the receiver capabilities by sending out the base layer and one or more enhancement layers depending on receiver capabilities and/or requirements of the targeted receivers. It may further be used to adapt the streaming rate to a varying channel capacity.

In an example embodiment, a scalable media stream may be transmitted using a real time transport protocol (RTP). The real time transport protocol stream may carry the one or more layers of the scalable media stream.

FIG. 1 shows a transmission system 100 according to an embodiment of the invention. A service provider 102 provides a media stream. The media stream may be transmitted over the internet 110 by an internet provider 104 using a cable connection to apparatus 114, for example a media player, a home media system, a computer, and/or the like. The media stream may also be transmitted by a transmitting station 106 to an apparatus 116 using a unicast transmission 126. The unicast transmission 126 may be bidirectional. The unicast transmission may be a cellular transmission such as a global system for mobile communications (GSM) transmission, a digital advanced mobile phone system (D-AMPS) transmission, code division multiple access (CDMA) transmission, wideband-CDMA (W-CDMA) transmission, a personal handy-phone system (PHS) transmission, a 3^{rd} generation systems like universal mobile telecommunications system (UMTS) transmission, a cordless transmission like a digital enhanced cordless telecommunication (DECT) transmission, and/or the like.

Further, the media stream from service provider 102 may be transmitted by a transmitting station 108 to an apparatus 118 using a broadcast or multicast transmission 128. The broadcast or multicast transmission may be a digital video broadcast (DVB) transmission according to the DVB-H (handheld), DVB-T (terrestrial), DVB-T2 (terrestrial 2, second generation), DVB-NGH (next generation handheld) standard, or according to any other digital broadcasting standard such as DMB (digital media broadcast), ISDB-T (Integrated Services Digital Broadcasting-Terrestrial), MediaFLO (forward link only), or the like.

Scalable video coding (SVC) may be used for streaming in a transmission. SVC provides enhancement layers carrying information to improve the quality of a media stream in addition to a base layer that provides a base quality, for example a low resolution video image and/or a low bandwidth mono audio stream.

In a digital transmission system, for example a DVB system, a physical layer pipe (PLP) may be used to transport one or more services. A service may be a media stream, a component of a media stream, such as a video or audio component of the media stream, a layer of a component of a layered coded media stream, and/or the like. A PLP may have a unique identification (ID), for example an 8-bit number, which uniquely identifies the PLP within the DVB system.

A PLP may be carried in one or more data frames. In an example embodiment, a PLP may also be carried in a slice of a data frame, so that several PLPs may be carried in the same data frame.

A receiver of a DVB transmission may want to receive a service carried in one of several PLPs. In order to receive the service, the receiver needs to parse signaling information associated with the service, for example Program Specific Information/System Information (PSI/SI), Electronic Program Guide (EPG) information, Electronic Service Guide (ESG) information, and/or the like. The receiver may then start parsing for the PLP comprising the service. However, the content of the PLP or PLPs in a data frame is unknown until data is parsed for higher layer signaling information.

When a scalable media stream is transmitted in one or more PLPs, a receiver may need to receive all PLPs of a data frame and parse the contents for higher layer information describing the layers comprised in the PLPs. Even if only the base layer or base layers are needed, all PLPs of the data frame may need to be received. The lack of information about the type of data that is delivered in a PLP may lead to a high penalty in terms of processing power, efficient battery usage, and the like.

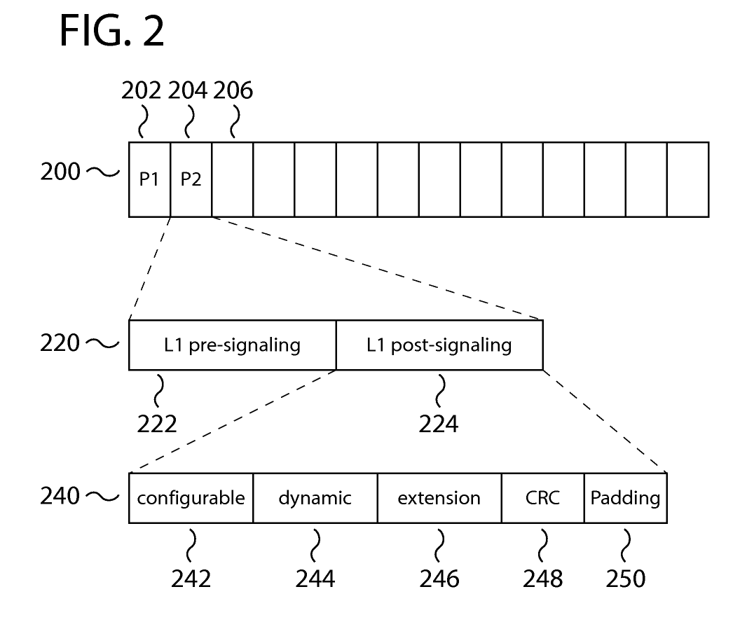

FIG. 2 shows an example embodiment of a data frame 200 comprising signaling information, for example a data frame in accordance with a DVB system such as DVB-T2. The data frame 200 may comprise layer 1 and layer 2 (lower layer) signaling information. Lower layer signaling information may be transmitted in symbols 202 and 204. Other data may be transmitted in frame 200 beginning at symbol 206, for example data transmitted in PLPs. Lower layer signaling information may be divided into signaling information P1 at one or more symbols 202 and signaling information P2 at one or more symbols 204. Signaling information P1 may indicate a transmission type and basic transmission parameters of the data frame. Signaling information P2 may comprise parameters that may be used to access the PLPs. In an example embodiment, signaling information P2 220 comprises L1 pre-signaling information 222 and L1 post-signaling information 224. L1 pre-signaling information 222 enables the reception of the L1 post-signaling information 224 and may be used to enhance the efficiency of the coding. L1 post-signaling information 224 comprises parameters for accessing the PLPs. In an example embodiment, L1 post-signaling information 224, 240 comprises a configurable part 242 and a dynamic part 244. An optional extension field 246 may further follow the dynamic part. Further a Cyclic Redundancy Code (CRC) field 248 may be added. Unused parts of the P2 signaling information may be stuffed by padding 250.

FIG. 3 shows symbols of a data frame, for example of a physical layer frame, of a DVB transmission, such as a DVB-T2 or a DVB-NGH transmission. Carriers of an orthogonal frequency division multiplex (OFDM) system are shown along axis 300. Axis 302 represents time. OFDM symbols 310, 312, 314, 316, 318 and 320 may be used to carry PLPs. For example, OFDM symbol 310 and a first part of OFDM symbol 312 transport a first PLP, marked by a first diagonal hatch. A second part of OFDM symbol 312 and a first part of OFDM symbol 314 transport a second PLP, marked by a second diagonal hatch. A second part of OFDM symbol 314 and OFDM symbol 316 transport a third PLP, marked by a cross hatch. Likewise, OFDM symbols 318 and 320 transport a forth and fifth PLP.

Layer 1 signaling may be used to inform the receiver of how the PLPs are mapped to the OFDM symbols. In an example embodiment, layer 1 signaling may comprise information about the mapping of the PLPs to DVB data packets.

In an example embodiment, PLPs of FIG. 3 may be used to transmit one or more layers of a scalable media stream. For example, the first PLP carried in OFDM symbols 310 and 312 may transmit a video base layer. The second and third PLP may carry a first and second video enhancement layer. The fourth and fifth PLP may transport a base audio layer and an enhancement audio layer, respectively. In this embodiment, a receiver receives multiple PLPs simultaneously for reception of at least the audio and video base layers.

In an example embodiment, a receiver receives a scalable media stream, wherein each layer of the scalable media stream is transmitted in a physical layer pipe. The receiver may be aware, for example from electronic service guide (ESG) information, that the scalable media stream comprises the following layers:
a base layer of an audio stream with a bit rate of 16000 bit/s;
an audio enhancement layer of the audio stream for a cumulative bit rate of 32000 bit/s;
a base layer of a video stream with a bit rate of 128000 bit/s for a resolution of 176×144 pixels at a frame rate of 15 frames/s and a low quality (quality=0);
an enhancement layer of the video stream with a cumulative bit rate of 256000 bit/s for a resolution of 176×144 pixels at a frame rate of 15 frames/s and a high quality (quality=1);
an enhancement layer of the video stream with a cumulative bit rate of 512000 bit/s for a resolution of 352×288 pixels at a frame rate of 30 frames/s and a low quality (quality=0); and a further enhancement layer of the video stream with a cumulative bit rate of 768000 bit/s for a resolution of 352×288 pixels at a frame rate of 30 frames/s and a high quality (quality=1).

The receiver may be an apparatus with a display of 240×160 pixels and a processor capable of decoding video streams at a bit rate of 256000 bit/s with a frame rate of 15 frames/s. The apparatus may also provide audio decoding capability of a bit rate of 16000 bit/s. Therefore, the receiver selects the base layer of the audio stream with 16000 bit/s. The receiver compares the properties of the base and enhancement video layers with its capabilities and concludes that it is capable of decoding the base and first enhancement layers of the video stream, providing a high quality at a resolution of 176×144 pixels and a frame rate of 15 frames/s.

From a received component identifier, for example a component identifier embedded in the L1 signaling, the receiver may derive the PLP unique ID values for the PLPs comprising the selected layers. For example, the receiver may find a mapping of the base layer of the audio stream to PLP-ID 0xA1 (hexadecimal value), and a mapping of the base and first enhancement layers to PLP-IDs 0xC1 and 0xC2, respectively. Thus, it will filter the incoming data stream for data from PLPs with a PLP-ID 0xA1, 0xC1 and 0xC2. The receiver may not receive data from PLPs with other unique IDs.

In another example embodiment, more than one layer of the scalable media stream is transmitted in a PLP. Thus, the number of PLPs used to transmit the scalable media stream may be reduced. In a further example embodiment, all layers of the scalable media stream are transmitted in one PLP. Therefore, only one PLP may transmit the scalable media stream. Processing requirements of a receiver may be reduced if only one PLP is to be received.

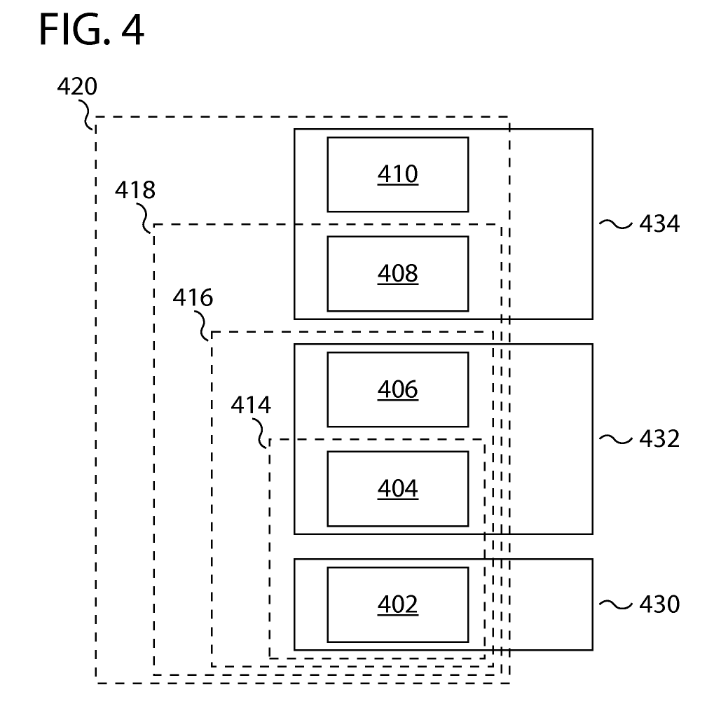

FIG. 4 shows an example embodiment of grouping layers of a scalable media stream. In addition, data type values may be assigned to the scalable media stream. In the example embodiment, a scalable media stream comprises a base layer 402, a first enhancement layer 404, a second enhancement layer 406, a third enhancement layer 408, and a fourth enhancement layer 410. At a receiver, the base layer 402 may be decoded independently to provide a basic quality. The first enhancement layer 404 may be decoded together with the base layer 402, as indicated by dashed line 414, to provide a first enhanced quality, for example by providing a higher video bit rate. The second enhancement layer 406 may be decoded together with the base layer 402 and the first enhancement layer 404, as indicated by dashed line 416, to provide a second enhanced quality, for example an enhanced video resolution of a video stream. The third enhancement layer 408 may be decoded with the base layer 402 and the first and second enhancement layers 404, 406, as indicated by dashed line 418, in order to provide a third enhanced quality, for example by providing a higher video frame rate of a video stream. The fourth enhancement layer 410 may be decoded with the base layer 402 and all other enhancement layers 404, 406, 408, as indicated by dashed line 420, in order to provide a fourth enhanced quality, for example by providing a higher color depth of a video stream.

The layers 402, 404, 406, 408 and 410 may be assigned to one or more groups. For example, base layer 402 may be assigned to a first group 430, the first and the second enhancement layers 404 and 406 may be assigned to a second group 432, and the third and the fourth enhancement layers 408 and 410 may be assigned to a third group 434.

In an example embodiment, a data type value may be assigned to at least one group of layers. The data type value may be a unique number identifying the group. In an example embodiment, numbers or values are assigned to the at least one group of layers in such a way that a first number, for example a low or lowest number, is assigned to a group of layers comprising the base layer or base layers of the scalable media stream, and a second number higher than the first number is assigned to at least one group comprising one or more enhancement layers. Higher numbers may be assigned to groups of enhancement layers in correspondence to the hierarchy relation of the enhancement layers, for example a hierarchy relation as shown by dashed lines 414, 416, 418 and 420. For example, the first group 430 may be assigned integer value 0x00 (hexadecimal). The second group 432 may be assigned integer value 0x01, as decoding of a layer of the second group 432 may require the decoding of the first group 430. The third group 434 may be assigned integer value 0x02, as decoding of a layer of the third group may require decoding of the first and second groups 430, 432. In an example embodiment, a fourth group may carry application layer forward error correction (FEC) data that may be used to correct errors in the other groups. The fourth group may be assigned integer value 0x03.

In an example embodiment the assignment of data type values may be the other way round. In such an embodiment, a first value, for example a high or highest number, is assigned to a group of layers comprising the base layer or base layers of the scalable media stream, and a second value lower than the first value may be assigned to at least one group comprising one or more enhancement layers. Lower numbers may be assigned to groups of enhancement layers in a way that corresponds to the hierarchy of the layers in the scalable media stream, for example in an ascending or descending way.

In a further example embodiment, at least one group of layers is mapped to a physical layer pipe. For example, the first group 430 may be mapped to a first physical layer pipe, the second group 432 may be mapped to a second physical layer pipe, and the third group 434 may be mapped to a third physical layer pipe. In another example embodiment, groups 430, 432 and 434 are mapped to a single physical layer pipe.

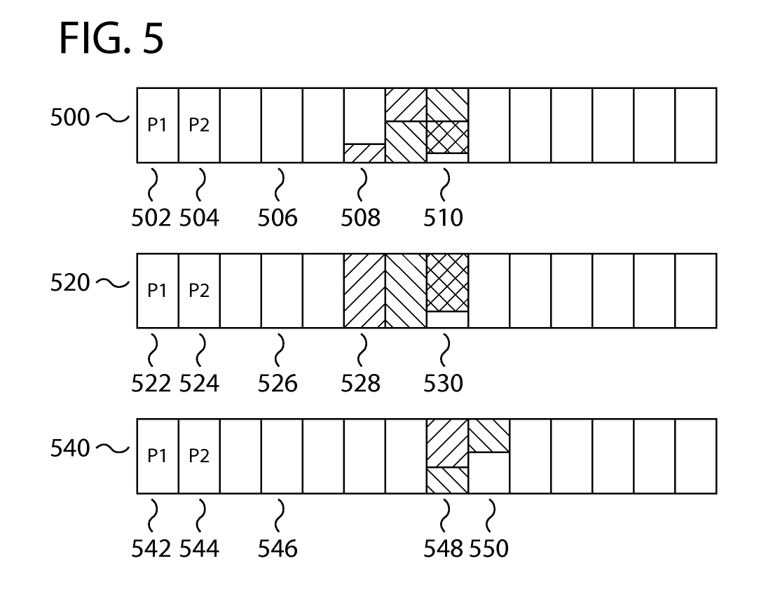

FIG. 5 shows an example embodiment of a series of data frames or packets 500, 520, 540 comprising a PLP carrying multiple layers of a scalable media stream. Data frames 500, 520, 540 may be transmitted sequentially and may be part of a continuous transmission of data frames. Further, data frames 500, 520, 540 may be assembled as data frame 200 of FIG. 2. A data frame 500, 520, 540 may start with symbols 502, 522, 542, respectively, comprising signaling information P1 and symbols 504, 524, 544, respectively, comprising signaling information P2.

A first data part 506, 526 and 546 of data frames 500, 520, 540, respectively, may carry data that is not of interest at a receiver and may not be processed. Data frames 500, 520, 540 may then carry data of a scalable media stream, for example as part of a service requested by the receiver. Data of the scalable media stream is transmitted in one or more PLPs. In an example embodiment, layers of a scalable media stream may be assigned to one or more groups as shown in FIG. 4. In an example embodiment, a first PLP may carry a first group 430 comprising a base layer. The first PLP in FIG. 5 is marked by a first diagonal hatch, and transmission of the first PLP may start in symbols 508, 528 and 548 of data frames 500, 520, 540, respectively. A second PLP, marked by a second diagonal hatch, may carry the second group 432 of layers comprising the first and second enhancement layers. Transmission of the second PLP may start following the first PLP. A third PLP, marked by a cross hatch, may carry the third group of layers 434 comprising the third and fourth enhancement layers. Transmission of the third PLP may start subsequent to the second PLP, for example at symbols 510 and 530. A data frame, for example data frame 540, may not carry the third PLP, for example as the amount of data of the third and fourth enhancement layer is low at the time of transmission of data frame 540. Subsequent to the PLPs carrying the media stream, further PLPs carrying other data may be transmitted starting at symbols 510, 530 and 550.

A data type value of a group of layers transmitted in a physical layer pipe in a data frame may be signaled in the data frame. In an example embodiment, a data type value is signaled in the L1 post-signaling information 224 of FIG. 2. For example, a data type value may be signaled in the dynamic part 244 of the L1 post-signaling 240 of the data frame 200. In an example embodiment, a reserved field may be used in the dynamic part 244 of the L1 post-signaling 240 for signaling a data type value, for example a field “reserved for future use”.

The dynamic part 244 of the L1 post-signaling 240 may have the structure shown in TABLE 1:

TABLE 1
L1 post-signaling - dynamic parameters

| Data | Number of bits |
|---|---|
| FRAME_IDX | 8 |
| SUB_SLICE_INTERVAL | 22 |
| TYPE_2_START | 22 |
| L1_CHANGE_COUNTER | 8 |
| START_RF_IDX | 3 |
| RESERVED_1 | 8 |
| for (i=0 ... NUM_PLP-1) { | |
| PLP_ID | 8 |
| PLP_START | 22 |
| PLP_NUM_BLOCKS | 10 |
| RESERVED_2 | 8 |
| } | |
| RESERVED_3 | 8 |
| for (i=0 ... NUM_AUX-1) { | |
| AUX_RFU | 48 |
| } | |

In an example embodiment, the RESERVED_{—}2 field is an 8 bit field. The RESERVED_{—}2 field refers to a PLP indicated by an identification PLP_ID. The field may be used to indicate the data type value of a group of layers of a scalable media stream carried in the corresponding PLP. In an example embodiment, multiple groups of layers are carried in the PLP, and the field comprises a lowest data type value of all groups of layers carried in the PLP.

In an example embodiment, a PLP with PLP_ID 0x10 carries the first group 430 and the second group 432 of FIG. 4. The first group 430 may be assigned data type value 0x02, and the second group may be assigned data type value 0x03. The dynamic part of the L1 post-signaling may then comprise the value 0x02 in the RESERVED_{—}2 field of the corresponding PLP.

In another example embodiment, a first group of layers comprises an audio base layer and a video base layer of a scalable media stream. A second group of layers may comprise video enhancement layers. A third group may comprise application layer forward error correction (FEC) data. An assignment of data type values to the groups may be done as shown in TABLE 2:

TABLE 2
Example of data type values

| Group comprising: | Data type value |
|---|---|
| Audio and video base layer | 0x00 |
| Video enhancement layers | 0x01 |
| Application layer FEC | 0x02 |
| user defined | 0x04-0xFF |

In a further example embodiment, the reserved field, for example the RESERVED_{—}2 field, may be split in two or more parts. A fixed number of bits of the RESERVED_{—}2 field may be assigned to the data type value, and another fixed number of bits may be assigned to a delta value. For example, the 4 least significant bits of the RESERVED_{—}2 field (bits 0 . . . 3) may be assigned to the data type value, and the 4 most signification bits (bits 4 . . . 7) may be assigned to the delta value. The delta value may indicate a next data frame signaling the same data type value.

In an example embodiment, a data frame signals in the RESERVED_{—}2 field a data type value of the current frame of 0x1 and a delta value of a next frame of 0x0 for a PLP. Thus, the following data frame may comprise again a data type value of 0x1 for the PLP. In another example embodiment, a data frame signals in the RESERVED_{—}2 field a data type value of 0x1 and a delta value of 0x2 for a PLP. Thus, the two next data frames may not comprise a data type value of 0x1 for the PLP, but a third data frame will again comprise a data type value of 0x1 for the PLP. In this way, a receiving apparatus that requires reception of a group of layers of a scalable media stream may know in advance which data frames to receive and which data frames to skip for reception of the group of layers.

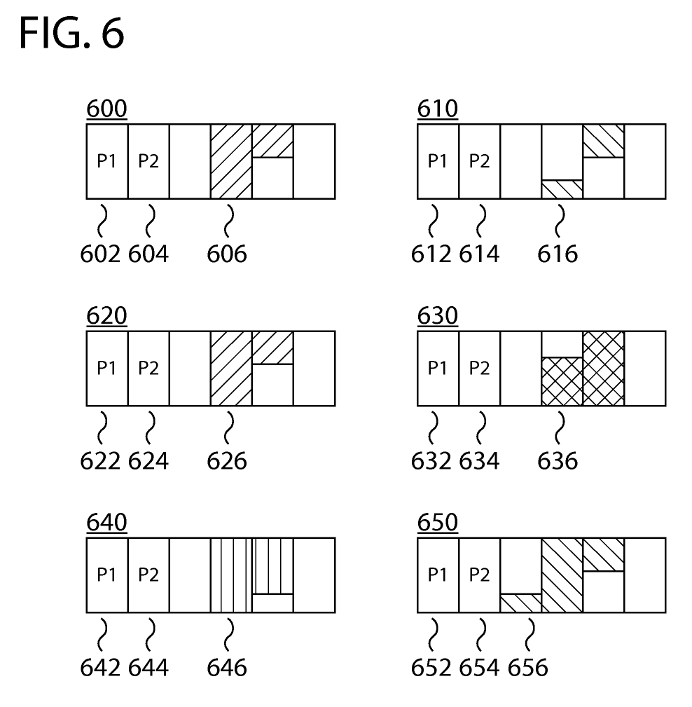

FIG. 6 shows an example embodiment of a transmission of a scalable media stream using signaling of groups of layers. FIG. 6 shows data frames 600, 610, 620, 630, 640 and 650 that may be transmitted sequentially. In the example embodiment, a receiving apparatus may receive the scalable media stream in an energy efficient way. The media stream may comprise a base layer and four enhancement layers, and the group assignment may be made as described in relation to FIG. 4. The groups of layers may be transmitted in a single PLP.

Data frames 600, 610, 620, 630, 640 and 650 carry signaling information P1 in symbols 602, 612, 622, 632, 642 and 652, respectively, and signaling information P2 in symbols 604, 614, 624, 634, 644 and 654, respectively. Signaling information P2 may comprise L2 post-signaling as shown in FIG. 3. L2 post-signaling may use the RESERVED_{—}2 field of the dynamic parameters for signaling a data frame value. The PLP carrying the scalable media stream is marked by a hatch. Transmission of the PLP starts in symbols 606, 616, 626, 636, 646 and 656. Different hatches may indicate the data type value signaled in the L2 post-signaling information and are used depending on the group or groups of layers that are transmitted in the PLP in data frame 600, 610, 620, 630, 640 and 650.

For example, the PLP in data frame 600 beginning at symbol 606 may comprise data of the first group 430 of FIG. 4 which is assigned the value 0x00. Thus, the value 0x00 is signaled in the transmission of the data frame, for example in the RESERVED_{—}2 field of the dynamic information of the L2 post-signaling information of data frame 600, as the first group is the only group in the PLP 606 of frame 600 and therefore the one with the lowest number. Thus, the PLP is marked with a first diagonal hatch.

In the following frame 610, transmission of the PLP carrying the media stream starts at symbol 616. The PLP may carry the second and third group of layers which are assigned the values 0x01 and 0x02. The lowest data type value (0x01) is signaled in the transmission of the data frame, for example in the RESERVED_{—}2 field of the dynamic information of the L2 post-signaling information of data frame 610. Thus, the PLP is marked with a second diagonal hatch.

In the next frame 620, transmission of the PLP carrying the media stream starts at symbol 626. The PLP may carry the first and third group of layers which are assigned the values 0x00 and 0x02. The lowest data type value (0x00) is signaled in the transmission of the data frame, for example in the RESERVED_{—}2 field of the dynamic information of the L2 post-signaling information of data frame 610. Thus, the first diagonal hatch is used again.

In the following frame 630, transmission of the PLP carrying the media stream starts at symbol 636. The PLP may carry the third group of layers which is assigned the value 0x02. The data type value 0x02 is signaled in the transmission of the data frame, for example in the RESERVED_{—}2 field of the dynamic information of the L2 post-signaling information of data frame 610. Thus, a third hatch (cross hatch) is used in FIG. 6.

In frame 640, transmission of the PLP carrying the media stream starts at symbol 646. The PLP may carry application FEC data which is assigned the value 0x03. The data type value 0x03 is signaled in the transmission of the data frame, for example in the RESERVED_{—}2 field of the dynamic information of the L2 post-signaling information of data frame 610. Thus, a vertical hatch is used.

In frame 650, transmission of the PLP carrying the media stream starts at symbol 656. The PLP may carry the second group of layers which is assigned the value 0x01. The data type value 0x01 is signaled in the transmission of the data frame, for example in the RESERVED_{—}2 field of the dynamic information of the L2 post-signaling information of data frame 610. Thus, the PLP is marked with a second diagonal hatch.

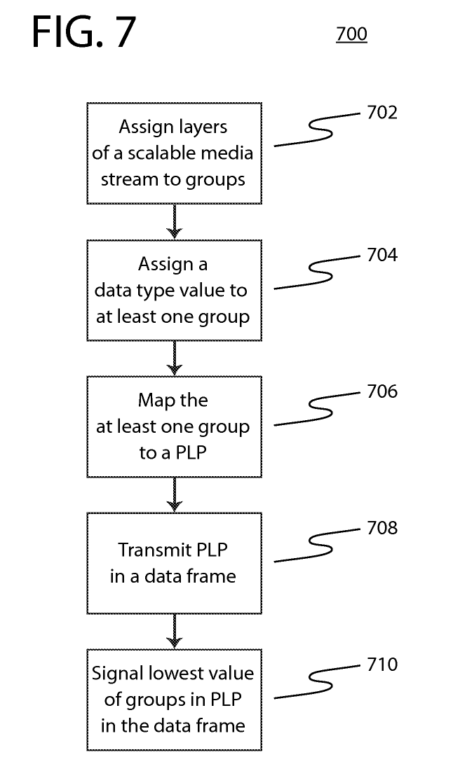

FIG. 7 shows an example embodiment method 700 for transmitting a scalable media stream in one or more PLPs. At block 702, layers of the scalable media stream are assigned to one or more groups, for example as described in relation to FIG. 4. At block 704, a data type value is assigned to at least one group of layers. At block 704, the at least one group is mapped to a PLP. The PLP is transmitted in a data frame at block 708, for example in data frames of FIGS. 5 and 6. At block 710, a data type value is signaled in the transmission of the data frame, for example a lowest data type value of groups transmitted in the physical layer pipe in the data frame.

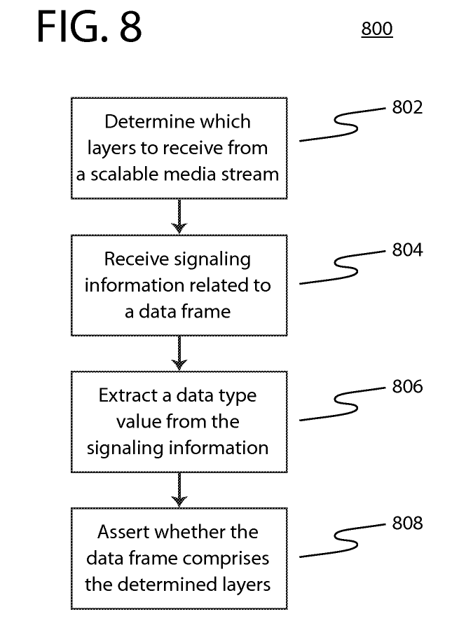

FIG. 8 shows a flowchart of an example embodiment method 800 for receiving a scalable media stream in one or more PLPs. At block 802, a determination is made as to which layer or layers to receive from a scalable media stream. In an example embodiment, this determination is made based on capabilities of a receiving apparatus, a user requirement and/or a user input. At block 804, signaling information related to a data frame is received, for example signaling information in the P1 and P2 symbols of the data frame, as described in relation to FIG. 2. The signaling information may comprise a data type value corresponding to a lowest data type value of groups of layers transmitted in a physical layer pipe in the data frame. For example, a data type value of 0x02 coded in a reserved field of the dynamic part of the L1 post-signaling may indicate that the lowest data type value of groups comprised in a PLP in the transmission of the data frame is 0x02. In other words, layers in data groups 0x00 and data groups 0x01 may not be comprised in the data frame for the PLP. At block 806, the data type value is extracted from the signaling information. At block 808 it is asserted whether data in the PLP in the data frame comprises the determined layer or layers, for example in a group of layers. The assertion may be based at least in part on the data type value. If data in the data frame comprises the determined layer or layers in the PLP, the data frame may be received. If data in the data frame does not comprise the determined layer or layers, the data frame may or may not be received. For example, reception of a data frame may be stopped after reception and analysis of the signaling information.

Returning to the example of FIG. 6, an apparatus comprising a receiver, for example apparatus 114, 116, 118 of FIG. 1, may decide to receive the base layer of the media transmission, but not the enhancement layers. Thus, the apparatus may determine that a data type value corresponding to the base layer is 0x00. Thus, the apparatus may determine to receive data frames which signal a data type value of 0x00. When the apparatus starts reception of data frame 600, it may analyse the signaling information P2 from symbol or symbols 604. In the dynamic part of the L1 post-signaling the apparatus will find a data type value 0x00, corresponding to a first group of layers. The apparatus may determine that the first group of layers comprises the base layer of the media stream. Thus, the apparatus may decide to receive the remaining part of the data frame. From the PLP starting at symbol 606 the apparatus will extract the base layer of the media stream.

When the apparatus starts reception of the next data frame 610, it will analyse the signaling information P2 from symbol or symbols 614. It will find a data type value 0x01, corresponding to a second group of layers. The apparatus may determine that the second group of layers comprises the first and second enhancement layers of the media stream, but not the base layer. Therefore, the apparatus may determine not to receive the remaining part of the data frame 610. The apparatus may decide to switch off the receiver during the remaining time of data frame 610.

Analysis of the signaling information in data frame 620 will yield a data frame value 0x00, corresponding to the first group of layers, comprising the base layer of the media stream. As described earlier, the PLP starting at symbol 626 of data frame 620 may comprise layers of the first group and of the third group of layers. The apparatus may receive data from the PLP in the data frame and extract the base layer from the data. The apparatus may discard data belonging to the third group of layers, for example data of a third and fourth enhancement layer.

Analysis of the signaling information from data frames 630, 640 and 650 and extraction of a data type value will result in values 0x02, 0x03 and 0x01. The apparatus will assert that data in the PLP of these frames will not comprise a base layer of the scalable media stream. Thus, after reception and analysis of the signaling information, the apparatus may determine not to receive the remaining part of the data frame and may switch off the receiver for the remaining time of the data frames.

In an example embodiment, a delta value is transmitted in the data frame indicating a next data frame signaling the same data type value. The delta value may be transmitted in the signaling information of a data frame. As described earlier, the delta value may be transmitted in the RESERVED_{—}2 field of the dynamic part of the L2 post-signaling transmitted in the P2 symbol or symbols. Returning again to the example of FIG. 6, data frame 600 may indicate a delta value of 0x01, indicating that data frame 620 comprises the same data type value as frame 600. From the information of the data type value 0x00 and the delta value 0x01 a receiving apparatus may conclude that data frame 610 does not comprise the base layer of the scalable media stream in the PLP, and that data frames 600 and 620 do comprise the base layer of the scalable media stream in the PLP, as the base layer belongs to the first group. After reception and analysis of the signaling information related to data frame 600, the receiving apparatus may decide to receive data frames 600 and 620, but to skip reception of data frame 610. Thus, energy may be saved at the receiving apparatus. Further, signaling information in data frame 620 may provide a data type value 0x00 and a delta value 0x03. Thus, the receiving apparatus may decide to skip reception of at least a subsequent data frame, for example data frames 630, 640 and 650, and may receive a next data frame again.

Still referring to the example of FIG. 6, another receiving apparatus may determine to receive layers of the scalable media stream from the first group and the second group of layers, but not from the third group. The apparatus may analyse the signaling information from data frame 600 and extract a data type value and a delta value. From the information of the data type value 0x00 and the delta value 0x01 the apparatus may conclude that data frame 610 does not comprise the base layer of the scalable media stream in the PLP, and that data frames 600 and 620 do comprise the base layer of the scalable media stream in the PLP, as the base layer belongs to the first group. Thus, the data frame 600 is received and data from the base layer of the scalable media stream is extracted from the PLP. However, no information is obtained whether data frame 610 comprises data of a first group of enhancement layers in the PLP.

The receiving apparatus may therefore start reception of data frame 610 and analyse the signaling information. Signaling information in data frame 610 may comprise a data type value 0x01 and a delta value 0x03. Thus, the receiving apparatus may receive data in the PLP of data frame 610 and the first and second enhancement layers from the second group of layers. The receiving apparatus may or may not receive data from the third group of layers comprised in the PLP in data frame 610. From the delta value 0x03, the receiving apparatus may conclude that a next data frame with the same data type value will be frame 650.

The receiving apparatus may continue with reception of data frame 620. The receiving apparatus may already know from signaling information in data frame 600 that data frame 620 comprises data of the scalable media stream of the first group of layers marked with data type value 0x00. The data type value in signaling information of data frame 620 may be extracted as 0x00 to confirm this. Further a delta value 0x03 is extracted. Thus, the receiving apparatus may conclude that the next frame with a data type value 0x00 is the frame after data frame 650.

From the combined information of signaling information from data frames 610 and 620, the receiving apparatus may conclude that it may skip reception of subsequent data frames 630 and 640, and that the next data frame comprising information of layers of the first and second group is in data frame 650. Again, the receiving apparatus may save energy by not scanning data frames 630 and 640 for data of the first and second group.

In another example embodiment, the delta value may indicate a next data frame signaling the same data type value or a lower data type value. In the example of FIG. 6, the signaling information of data frame 600 may indicate a data type value of 0x00 and a delta value of 0x01 in the signaling information, as the next data frame with data from the first group of layers is transmitted in data frame 620 again. Data frame 610 may indicate a data type value 0x01 and a delta value of 0x00 in the signaling information, as data frame 620 comprises a smaller data value 0x00. In this way, a receiving apparatus may be aware of the next data frame it needs to receive. It may directly use the delta value of a frame without combining delta values relating to different groups of layers that are received in different frames.

In an example embodiment, a mapping between an operation point and a data type value may be signaled in a session description file, for example a file according to the Session Description Protocol (SDP). The SDP is defined by the Internet Engineering Task Force (IETF) as RFC 4566 (“Request For Comments”, downloadable on http://www.ietf.org) in July 2006 and is included by reference. SDP is used to describe information on a session like media details, transport addresses, and other session description metadata. However, any other format that may be used to describe information of a session may be used.

An operation point is a set of media streams of a service that may be considered by a service provider to match capabilities and/or requirements of a group of receiving apparatuses. An operation point may be characterized by one or more attributes describing properties of the set of the media streams such as a spatial resolution of a video stream, a frame rate of the video stream, a color bit depth, a number of channels of an audio stream, a quality level of the audio and/or video stream, an error robustness level, a maximum overall bit rate of the service, and/or the like.

In an example embodiment, an operation point may be defined by a base layer of an audio stream and a base layer of a video stream. Another operation point may for example add one or more enhancement layers of the video stream that is coded as an SVC layer, for example for additional spatial resolution.

The selection of an operation point may depend on one or more capabilities of the receiving apparatus, for example a display resolution, a maximum frame rate, a capability of a video processor, a total data processing capability reserved for media streaming, audio and video codecs installed, and/or the like. The selection of an operation point may also depend on a user preference and/or a user input.

The following extract shows an example of signaling a mapping between an operation point and a data type value in a session description file according to the session description protocol (SDP). In an example embodiment, signaling a mapping between an operation point and a data type value in a session description file may use an attribute “a=” tag, such as “a=PLP-data-type:” followed by an integer number representing the data type value. The example shows three operation points with two video layers and two audio layers and one FEC stream. The first operation point contains the base layer of the video stream and the base representation of the audio stream, for example an audio stream comprising two audio channels. The second operation point may add a media stream comprising a video enhancement layer and a media stream containing additional audio channels, for example for surround sound. The third operation point adds an additional stream that comprises a FEC stream.

### Example

v=0
o=alice 2890844526 2890844526 IN IP4 192.0.2.12
s=Multiple operation points
i=Scalable media with multiple operation points
c=IN IP4 192.0.2.12
t=0 0
m=audio 48000 RTP/AVPF 97
a=rtpmap:97 mpeg4-generic/48000/2
a=fmtp:97 streamType=5; profile-level-id=44; a=PLP-data-type: 0
a=mid:A1
m=video 48002 RTP/AVP 98
a=rtpmap:98 H264/90000
a=fmtp:98 profile-level-id=4d400a; packetization-mode=0;
a=PLP-data-type: 0
a=mid:V1
m=audio 48004 RTP/AVP 99
a=rtpmap:99 mpeg4-generic/48000/6
a=fmtp:99 streamType=5; profile-level-id=55;
a=PLP-data-type: 1
a=mid:A2
a=depend:99 lay A1:97
m=video 48006 RTP/AVP 100
a=rtpmap:100 H264-SVC/90000
a=fmtp:100 profile-level-id=4d400a; packetization-mode=1;
a=PLP-data-type: 1
a=mid:V2
a=depend:100 lay V1:98
m=application 48010 UDP/ALFEC *
b=AS:500
a=PLP-data-type: 2
a=mid:FEC

The first paragraph beginning with a media “m=” tag identifies that an audio base layer is sent in a group of layers with a data type value “0”. The second paragraph beginning with a media tag identifies that a video base layer is sent in the same group of layers with a data type value “0”. As the audio stream and video stream are both assigned the data type value 0, they belong to the same group of layers. The tag “a=mid” assignes a media identifier to the audio and video base layer. The audio base layer is assigned identifier “A1”, the video base layer is assigned identifier “V1”.

The next paragraph beginning with a media tag identifies that an audio layer is sent in a group of layers with a data type value “1”. The tag “a=mid” assignes a media identifier to the audio layer “A2”. The tag beginning with “a=depend” defines a dependency on the layer identified by identifier “A1”, the audio base layer.

The next paragraph beginning with a media tag identifies that a video layer is sent in a group of layers with a data type value “1”. The tag “a=mid” assignes a media identifier to the video layer “V2”. The tag beginning with “a=depend” defines a dependency on the layer identified by identifier “V1”, the video base layer.

The next paragraph identifies that forward error correction (FEC) data is sent in a group of layers identified by a data type value “2”. FEC data may be identified by media identifier “FEC”.

By mapping an operation point to a data type value, an assignment of layers of the scalable media stream is made to a data type value.

In an example embodiment, an assignment is made assigning layers of the scalable media stream to one or more groups of layers. Another assignment is made assigning at least one of the one or more groups of layers to a data type value.

In another example embodiment, a mapping between an operation point and a data type value may be transmitted in an electronic service guide (ESG). In a further example embodiment, a mapping between an operation point and a data type value may be transmitted in a descriptor related to program specific information/system information (PSI/SI) of a digital video broadcasting system.

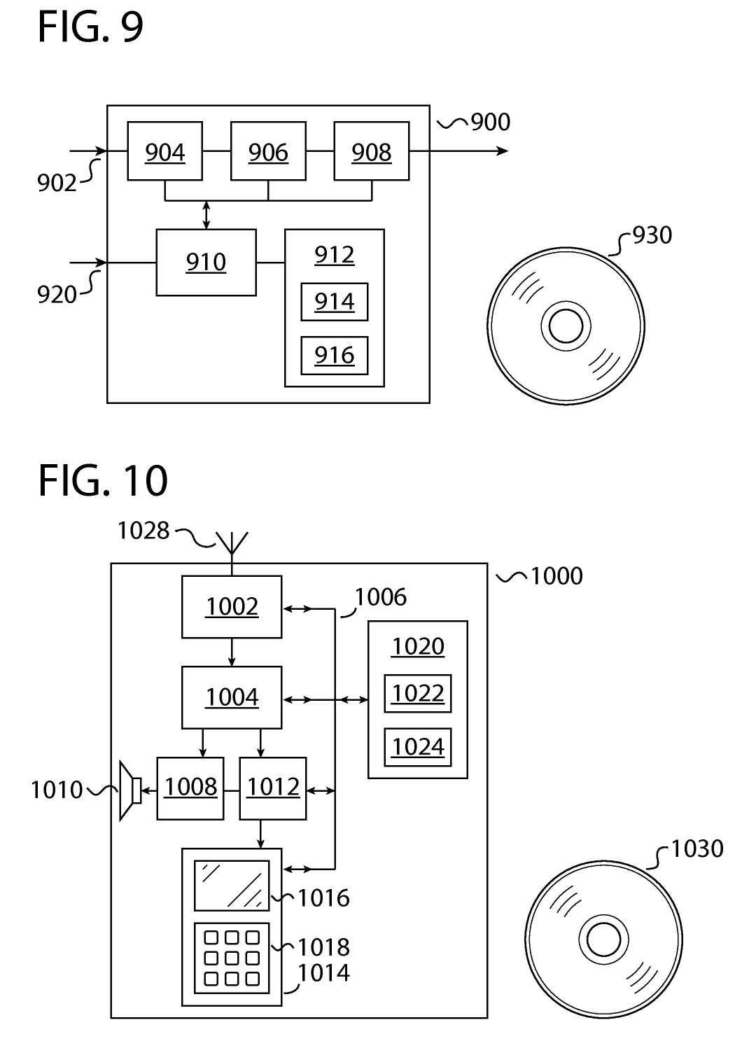

FIG. 9 shows an example embodiment of an apparatus 900 configured to transmit data of a scalable media stream, for example internet provider 104 or transmitting station 106, 108 of FIG. 1. Apparatus 900 receives a media stream at port 902, for example from service provider 102 of FIG. 1. Layered coder 904 produces base and enhancement layers of the media stream which are cast into transmission packets or data frames at packetizer 906. Transmission data frames are forwarded to transmitter 908 which prepares data frames for transmission, for example over the air transmission or cable transmission. Controller 910 controls the operation of the layered coder 904, packetizer 906 and transmitter 908. For example, controller 910 defines the properties of the layers, such as the bit rate, audio bandwidth, number of audio channels, audio codecs, video resolution, video frame rate, video codecs, and/or the like. Controller 910 may also add forward error correction (FEC) data. Controller 910 provides information related to the layers to packetizer 906. In an example embodiment, controller 910 assigns layers of the scalable media stream to one or more groups and assigns a data type value to at least one group of layers. Controller 910 may further map the at least one group of layers to a physical layer pipe. Controller 910 may also assemble a session description file including information on the data type values of groups of layers and the operation points, for example a session description file in accordance with a session description protocol (SDP). Packetizer 906 may put the session description file in a data frame for transmission.

Controller 910 may be a digital signal processor (DSP), a microcontroller unit (MCU), a reduced instruction set controller (RISC), or any other kind of processor with sufficient processing capabilities.

Apparatus 900 may further comprise memory 910 storing software for running apparatus 900. For example, software instructions for running the controller 910 may be stored in one or more areas 914 and 916 of memory 912. Memory 912 may comprise volatile memory, for example random access memory (RAM), and non volatile memory, for example read only memory (ROM), FLASH memory, or the like. Memory 912 may comprise one or more memory components. Memory 912 may also be embedded with processor 910. Software comprising data and instructions to run apparatus 900 may also be loaded into memory 912 from an external source. For example, software may be stored on an external memory like a memory stick comprising one or more FLASH memory components, a compact disc (CD), a digital versatile disc (DVD) 930, and/or the like. Software or software components for running apparatus 900 may also be loaded from a remote server, for example through the internet.

FIG. 10 shows an example embodiment of an apparatus 1000 configured to receive data frames or packets of a media stream, for example apparatus 114, 116, 118 of FIG. 1. Apparatus 1000 may be a mobile apparatus, for example a mobile phone. Apparatus 1000 comprises a receiver 1002 configured to receive a transmission of a scalable media stream comprising one or more layers. In an example embodiment, the transmission may be received through antenna 1028. In another example embodiment, the transmission may be received through a cable connection. Incoming packets of the media stream are forwarded to a controller or processor 1004. Processor 1004 may be a digital signal processor (DSP), a microcontroller unit (MCU), a reduced instruction set controller (RISC), or any other kind of processor with sufficient processing capabilities. Processor 1004 may perform a packet decapsulation and extraction of signaling information. Thus, processor 1004 may extract lower layer signaling information and/or higher layer signaling information comprising an ESG and/or a session description file. By extracting lower layer signaling information, processor 1004 may identify an association of a data frame to one or more PLPs. Further, by extracting signaling information, processor 1004 may identify a data type value corresponding to a lowest data type value of groups of layers transmitted in a PLP in the data frames. For example, processor 1004 may extract the data type value from the dynamic part of the L1 post-signaling information, as shown in FIG. 2. Processor 1004 may also assert whether data in the PLP in the data frame comprises a determined layer or layers in the group of layers. Processor 1004 may base the assertion at least in part on the data type value.

Processor 1004 may be further configured to determine which layer or layers to receive from a scalable media stream, for example depending on the capabilities of the apparatus 1000 and/or depending on a user preference and/or a user input, for example an input on keyboard 1018 of user interface 1014.

Apparatus 1000 may comprise one or more memory blocks 1020. Memory 1020 may comprise volatile memory 1022, for example random access memory (RAM). Volatile memory 1022 may be used to store data received from receiver 1002, for example data of a scalable media stream at various processing and filtering stages, configuration data for apparatus 1000, and/or the like. Processor 1004 may communicate with memory blocks 1020 through a bidirectional bus 1006 in order to read and store data and/or instructions.

Filtered audio layers are output from processor 1004 to audio decoder 1008. Audio decoder 1008 decodes the audio data in the filtered audio layers and converts the data to an analog audio signal. Analog audio signal may be played back on loudspeaker 1010. In an example embodiment, the analog audio signal is played back on an audio headset.

Filtered video layers are forwarded from processor 1004 to video decoder 1012 which prepares the video data of the video layers for play back on user interface 1014. User interface comprises a display 1016. User interface 1014 may further comprise a keyboard 1018 for entering user data. User data may comprise a user preference, for example a user preference for viewing a scalable media stream at a certain video and/or audio quality, resolution, frame rate, and the like. A user preference may be used by processor 1004 to determine which audio and video layers of the scalable media stream to filter and which layers to discard.

Memory 1020 may also comprise non volatile memory 1024, for example read only memory (ROM), FLASH memory, or the like. Non-volatile memory 1024 may be used to store software instructions for processor 1004. At least a part of memory 1020 may also be embedded with processor 1004. Software comprising data and instructions to run apparatus 1000 may also be loaded into memory 1020 from an external source. For example, software may be stored on an external memory like a memory stick comprising one or more FLASH memory components, a compact disc (CD), a digital versatile disc (DVD) 1030, or the like. Software or software components for running apparatus 1000 may also be loaded from a remote server, for example through the internet.

Without in any way limiting the scope, interpretation, or application of the claims appearing below, a technical effect of one or more of the example embodiments disclosed herein may be that groups of layers of a scalable media stream may be identified in the lower layer signaling information of a data frame. Another technical effect of one or more of the example embodiments disclosed herein may be that a receiving apparatus is able to identify data frames for reception of a service comprising a scalable media stream from the lower layer signaling information. Another technical effect of one or more of the example embodiments disclosed herein may be that a receiving apparatus may determine to skip reception of one or more whole data frames without receiving the signaling information in the data frames.

Embodiments of the present invention may be implemented in software, hardware, application logic, an application specific integrated circuit (ASIC) or a combination of software, hardware and application logic. The software, application logic and/or hardware may reside on an apparatus or an accessory to the apparatus. For example, the receiver may reside on a mobile TV accessory connected to a mobile phone. If desired, part of the software, application logic and/or hardware may reside on an apparatus, part of the software, application logic and/or hardware may reside on an accessory. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
assigning layers of a scalable media stream to one or more groups;
assigning a data type value to at least one group;
mapping the at least one group to a physical layer pipe;
transmitting data of the scalable media stream in the physical layer pipe in a data frame; and
signaling in the data frame a lowest data type value of groups transmitted in the physical layer pipe in the data frame.

2. The method of claim 1, wherein a first value of the data type value corresponds to a group comprising a base layer of the scalable media stream, and wherein a second value of the data type value higher than the first value corresponds to a group comprising one or more enhancement layers.

3. The method of claim 1, further comprising:
transmitting a delta value in the data frame indicating a next data frame signaling the same data type value or a lower data type value.

4. The method of claim 1, wherein the transmission is a transmission of a DVB-T2 system, and wherein the data type value is signaled in the L1 post-signaling of the DVB-T2 system.

5. The method of claim 1, further comprising:
transmitting a session description file comprising the assignment of layers of the scalable media stream to one or more groups and the assignment of the data type value to the at least one group.

6. The method of claim 1, wherein the media stream comprises one or more layers of a video stream.

7. The method of claim 1, wherein the media stream comprises one or more layers of an audio stream.

8. The method of claim 1, wherein the media stream comprises forward error correction data.

9. A method, comprising:
determining at least one layer to receive from a scalable media stream;
receiving signaling information related to a data frame, wherein the signaling information comprises a data type value corresponding to a lowest data type value of groups transmitted in a physical layer pipe in the data frame;
extracting the data type value from the signaling information; and
asserting whether data in a physical layer pipe in the data frame comprises the determined at least one layer in a group based at least in part on the data type value.

10. The method of claim 9, further comprising stopping reception of the data frame if data in the physical layer pipe in the data frame does not comprise the determined at least one layer.

11. The method of any of claim 9, wherein a first value of the data type value corresponds to a group comprising a base layer of the scalable media stream, and wherein a value of the data type value higher than the first value corresponds to a group comprising enhancement layers.

12. The method of claim 9, further comprising:
extracting a delta value from the signaling information indicating a next data frame signaling the same data type value or a lower data type value than the data type value extracted from the signaling information; and
asserting whether data in a physical layer pipe in a subsequent data frame comprises the determined at least one layer in a group based at least in part on the data type value and the delta value.

13-34. (canceled)

35. An apparatus comprising:
a controller configured to assign layers of a scalable media stream to one or more groups;
wherein the controller is further configured to assign a data type value to at least one group;
wherein the controller is further configured to map the at least one group to a physical layer pipe;
a transmitter configured to transmit data of the scalable media stream in the physical layer pipe in a data frame; and
wherein the transmitter is further configured to transmit in the data frame signaling information comprising a lowest data type value of groups transmitted in the physical layer pipe in the data frame.

36. An apparatus according to claim 35, wherein a first value of the data type value corresponds to a group comprising a base layer of the scalable media stream, and wherein a second value of the data type value higher than the first value correspond to a group comprising one or more enhancement layers.

37. An apparatus according to claim 35, wherein the transmitter is further configured to transmit a delta value in the data frame indicating a next data frame signaling the same data type value or a lower data type value.

38. An apparatus, comprising:
a controller configured to determine at least one layer to receive from a scalable media stream;
a receiver configured to receive signaling information related to a data frame, wherein the signaling information comprises a data type value corresponding to a lowest data type value of groups transmitted in a physical layer pipe in the data frame;
wherein the controller is further configured to assert whether data in a physical layer pipe in the data frame comprises the determined at least one layer in a group based at least in part on the data type value.

39. An apparatus according to claim 38, wherein the receiver is further configured to stop reception of the data frame if data in the physical layer pipe in the data frame does not comprise the determined at least one layer.

40. An apparatus according to claim 38, wherein a first value of the data type value corresponds to a group comprising a base layer of the scalable media stream, and wherein a value of the data type value higher than the first value corresponds to a group comprising enhancement layers.

41. An apparatus according to claim 38, wherein the controller is further configured to extract a delta value from the signaling information indicating a next data frame signaling the same data type value or a lower data type value than the data type value extracted from the signaling information; and
asserting whether data in a physical layer pipe in a subsequent data frame comprises the determined at least one layer in a group based at least in part on the data type value and the delta value.

42. An apparatus according to claim 38, wherein the receiver is a receiver according to a DVB-T2 system, and wherein the data type value is signaled in the L1 post signaling of the DVB-T2 system.

43. An apparatus according to claim 38, wherein the receiver is further configured to receive a session description file comprising an assignment of the scalable media stream to one or more groups and an assignment of the at least one group to the data type value.

44. An apparatus according to claim 38, wherein the media stream comprises one or more layers of a video stream.

45. An apparatus according to claim 38, wherein the media stream comprises one or more layers of an audio stream.

46. A computer program product comprising a computer-readable medium bearing computer program code embodied therein for use with a computer, the computer program code comprising:
code for determining at least one layer to receive from a scalable media stream;
code for receiving signaling information related to a data frame, wherein the signaling information comprises a data type value corresponding to a lowest data type value of groups transmitted in a physical layer pipe in the data frame;
code for extracting the data type value from the signaling information; and
code for asserting whether data in a physical layer pipe in the data frame comprises the determined at least one layer in a group based at least in part on the data type value.
